(19) United States
(12) Patent Application Publication
(10) Pub. No.: US 2006/0185888 A1
(43) Pub. Date: Aug. 24, 2006

(54) Electronic apparatus including cable holder

(75) Inventors: Shigeto Yamada, Echizen-city (JP); Yoshikazu Yonezu, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/354,949

(22) Filed: Feb. 16, 2006

(30) Foreign Application Priority Data
Feb. 23, 2005 (JP) 2005-047151

(51) Int. Cl. H01B 7/00

(52) U.S. Cl. 174/135

(57) ABSTRACT

In an electronic apparatus in which cables with different kinds of signals transmitted are laid, an electronic apparatus including a cable holder which holds the two different kinds of cables and is capable of preventing mutual interference by noises and unwanted radiations occurring between the cables is provided. A loose wires holding part which holds loose wires in which analog signals are transmitted, and a flat cable holding part which holds a flat cable in which digital signals are transmitted are provided in a cable holder. The loose wires holding part is formed by notching both side walls of a base part, the flat cable holding part is formed by a plurality of holding plates which are extended from a base part, and the flat cable holding part is formed so that the flat cable is in contact with the chassis bottom plate or the chassis side plate.

### The present application is based on and claims priority of Japanese patent application No. 2005-047151 filed on Feb. 23, 2005, the entire contents of which are hereby incorporated by reference.

### BACKGROUND OF THE INVENTION

1.Field of the Invention

The present invention relates to an electronic apparatus in which a flat cable and a plurality of loose wires are laid.

2.Description of the Related Art

Conventionally, as a cable holder for holding and laying cables in an electronic apparatus, Japanese Patent Laid-Open Publication No. 11-289632 (patent document 1) discloses “cable holder” or the like. This prior art proposes a method which includes a bottom surface that is made of a synthetic resin material having elasticity, is in a groove shape in sectional view and extends in a longitudinal direction, and a first and a second side walls which are opposed to each other and parallel with each other, and is constructed by forming a locking piece projected at an end edge in a longitudinal direction of the first side wall and having notches at both ends, and a long hole which is constituted of a linear part in the longitudinal direction and bent parts which are both ends of the linear part extending to the bottom surface, and allows the locking piece of the first side wall to be inserted and engaged therein.

In the above described prior art, for example, in the patent document 1, the cable holder holds a cable in such a manner as to carry the cable in the range of the length of the cable holder by the bottom surface and both the side walls, and can hold a cable with a single core or a cable with a plurality of cores, but this cable holder cannot separately hold a plurality of cables in which various signals are transmitted in one cable holder. Therefore, there is the problem that in order to separately hold the cables of which mutual interference is feared to prevent mutual interferences of noises and unwanted radiations among a plurality of cables, a separate cable holder from this cable holder needs to be disposed or the like. Generally, it is desirable to separately hold flat cables in which high-frequency digital signals are transmitted and loose wires in which low-frequency analog signals are transmitted in AV (Audio Visual) apparatuses, personal computers and the like, and in order to reduce unwanted radiations from the flat cables in which digital signals are transmitted, it is necessary to mount shield members to the flat cables additionally.

### SUMMARY OF THE INVENTION

The present invention solves the problems in the prior art, which are incapability of separately holding the cables which are used according to the kinds of the signals to be transmitted, the wiring method of a flat cable which has the fear of an unwanted radiation and the like, and to provide an electronic apparatus including a cable holder capable of holding two kinds of cables with different kinds of the above described signals in one cable holder, and also capable of preventing mutual interferences of noises and unwanted radiations.

An electronic apparatus including a cable holder of a first aspect is an electronic apparatus including a cable holder which holds a flat cable constructed by a plurality of cores and a plurality of loose wires, which are laid, wherein a slit part which sandwiches the flat cable by alternately disposing the flat cable is formed at a tip end of the cable holder, and a notch part which holds the plurality of loose wires in a bound state is formed at a rear end side that is located at an opposite side from the tip end.

According to the construction of the first aspect, in the electronic apparatus including a cable holder which holds a flat cable constructed by a plurality of cores and a plurality of loose wires, which are laid, a slit part which sandwiches the flat cable by alternately disposing the flat cable is formed at a tip end of the cable holder, and a notch part which holds the plurality of loose wires in a bound state is formed at a rear end side that is located at an opposite side from the tip end.

The electronic apparatus including a cable holder of a second aspect is the electronic apparatus including the cable holder according to the first aspect, wherein the cable holder is formed in an L-shape.

According to the construction of the second aspect, in the cable holder, the slit part which holds the flat cable and the notched part which holds the loose wires in the bound state are formed in the L-shape.

The electronic apparatus including the cable holder of a third aspect is the electronic apparatus including the cable holder according to the first aspect, wherein the cable holder is formed in a planar shape.

According to the third aspect, in the cable holder, the slit part which holds the flat cable and the notched part which holds the loose wires in the bound state are formed in the planar shape.

The electronic apparatus including a cable holder of a fourth aspect is the electronic apparatus including the cable holder according to anyone of the first to third aspects, wherein a locking stopper is formed at a tip end of the cable holder.

According to the construction of the fourth aspect, the locking stopper which prevents the flat cable from removing is formed at the tip end of the cable holder.

### BRIEF DESCRIPTION OF THE DRAWINGS

FIG. 1 is an explanatory perspective view showing a state in which a flat cable and loose wires are held by a cable holder which shows embodiment 1 of the present invention;

FIG. 2 is an explanatory plane view showing a plane of the cable holder in the present invention;

FIG. 3 is an explanatory side view of the cable holder formed in an L-shape in the present invention;

FIG. 4 is an explanatory front view showing a front of the cable holder in the present invention;

FIG. 5 is an explanatory plane view showing a chassis of a DVD device;

FIG. 6 is an explanatory enlarged side sectional view of showing a projected portion formed on the chassis in the present invention;

FIG. 7 is an explanatory plane view showing a state in which the cable holders are mounted to the chassis in the present invention;

FIG. 8 is an explanatory enlarged plane view showing a state in which a cable holder is mounted to the chassis in the present invention;

FIG. 9 is an explanatory plane view showing a state in which the cables are laid by being held by the cable holder in the present invention;

FIG. 10 is an explanatory enlarged side sectional view showing a state in which the cable holder in the present invention is caused to hold the cables and fixed by being pressed by a DVD unit;

FIG. 11 is an explanatory plane view showing a plane of a cable holder formed in a planar shape which shows embodiment 2;

FIG. 12 is an explanatory side view showing a side surface of the cable holder in the present invention;

FIG. 13 is an explanatory plane view showing a state in which the cables are laid by being held by the cable holder in the present invention; and

FIG. 14 is an explanatory plane view showing a state in which a cable holder with a hook formed at a base part showing embodiment 3 of the present invention is mounted to a chassis.

### DETAILED DESCRIPTION OF THE PREFERRED EMBODIMENTS

As above, the present invention relates to an electronic apparatus including a cable holder which separately holds in one holder cables with different kinds of wires due to signals with different frequencies being transmitted, and prevents an unwanted radiation emitted from the cables. In the following description of embodiments, embodiment 1 describes that cables are laid by mounting a cable holder formed in an L-shape to a DVD device. Embodiment 2 describes that a cable holder formed in a planar shape is mounted to a DVD device. Embodiment 3 describes a structure that an L-shaped cable holder is locked by a locking claw. According to them, details of the present invention will be described.

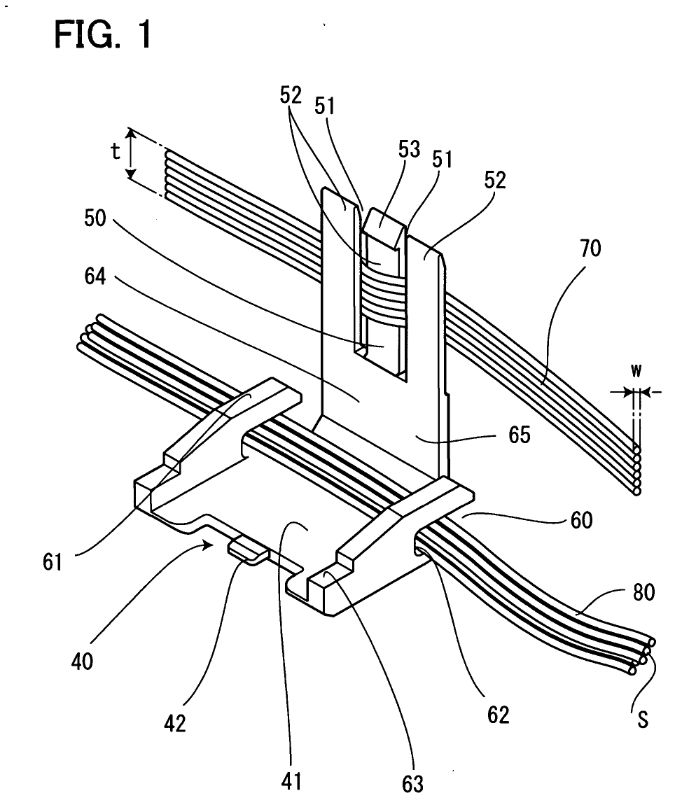

Hereinafter, the embodiments as the best modes for carrying out the present invention will be described with reference to FIG. 1 to FIG. 14. Naturally, it goes without saying that the present invention is easily applicable to the other devices and apparatuses than those explained in the embodiments without departing from the spirit of the present invention.

### Embodiment 1

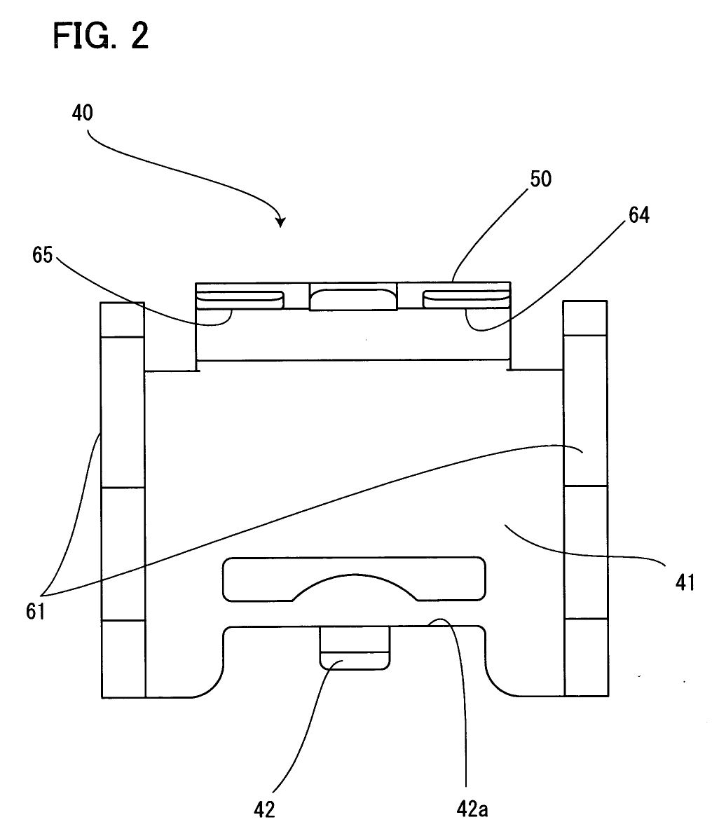

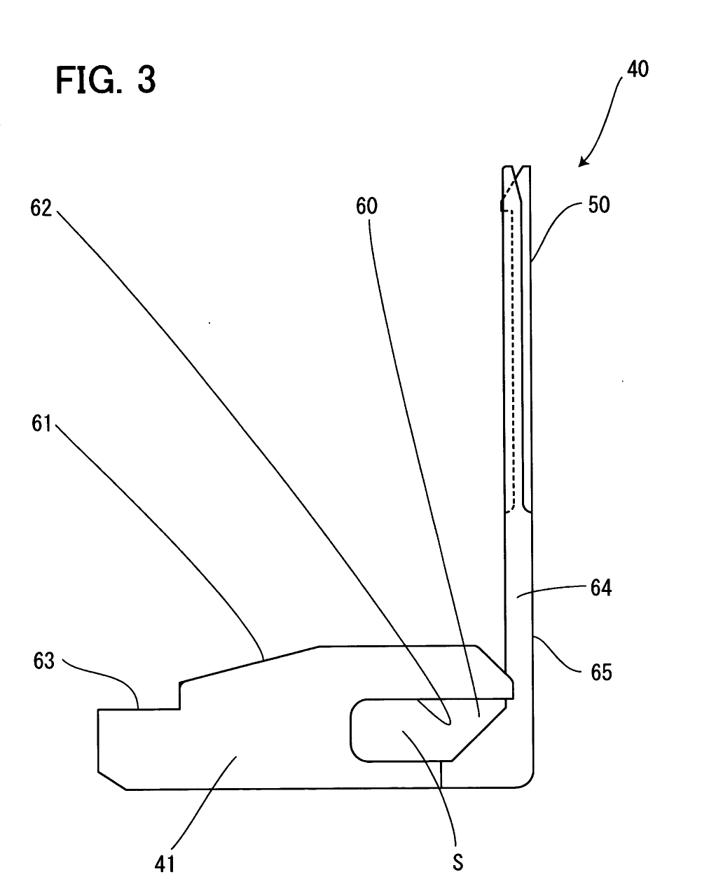

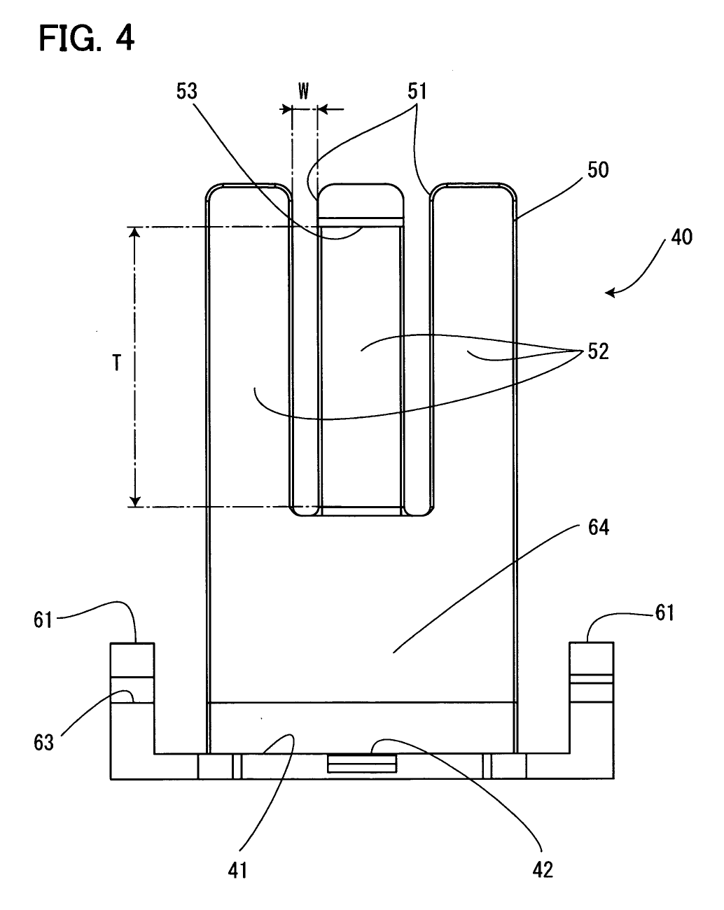

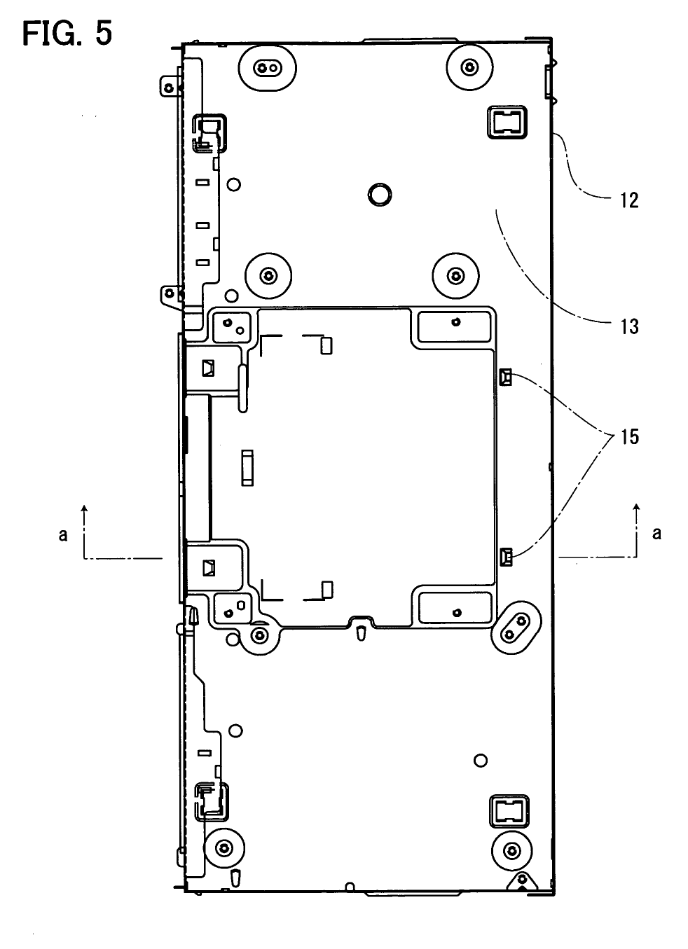

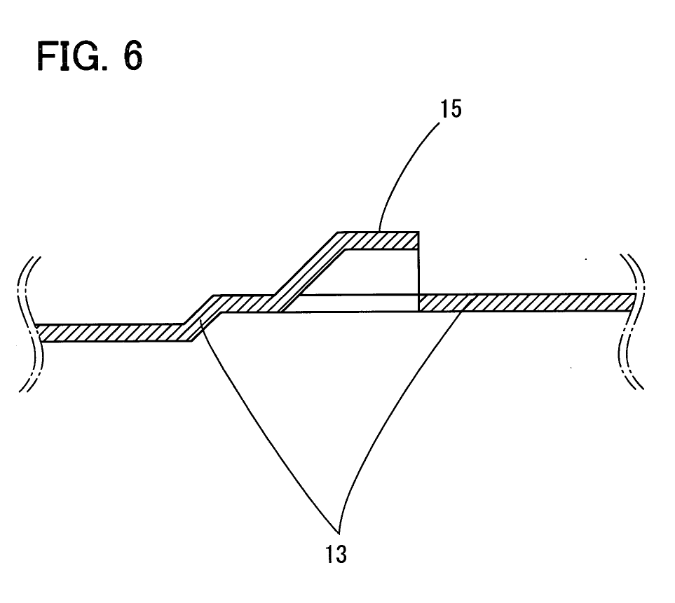

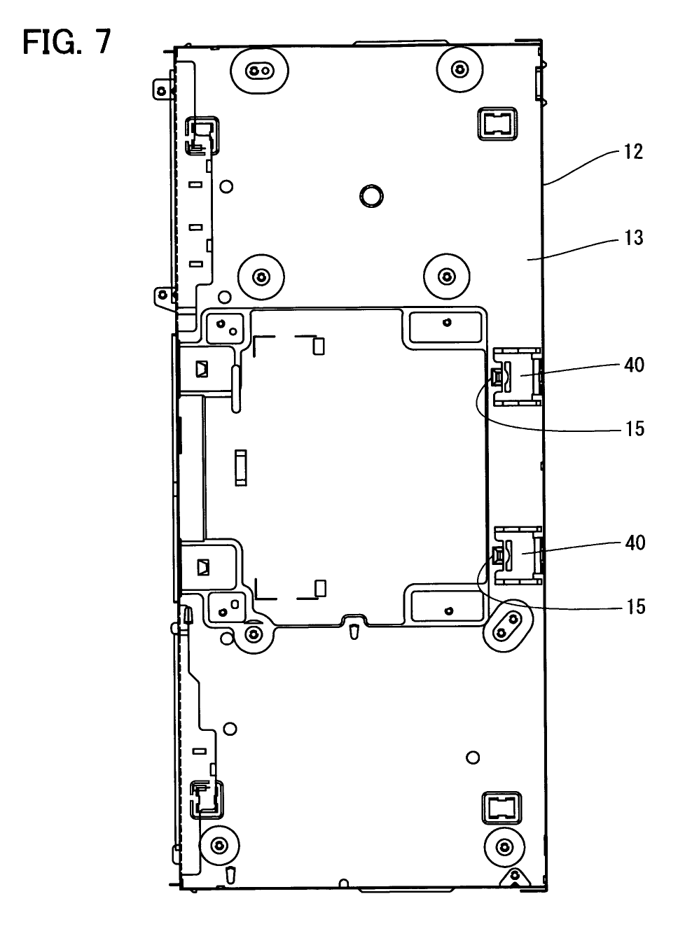

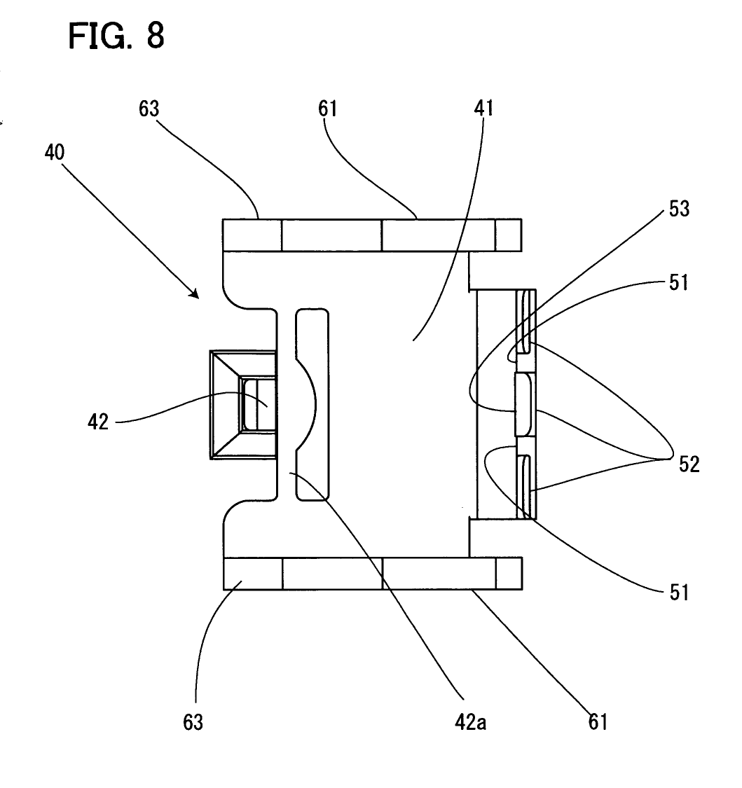

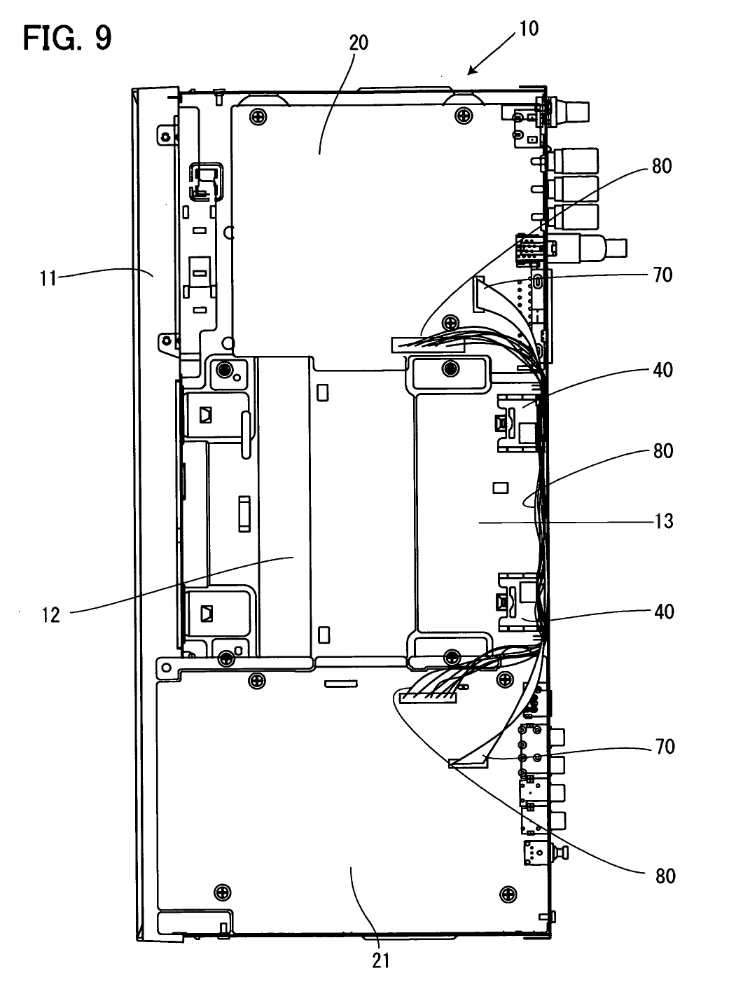

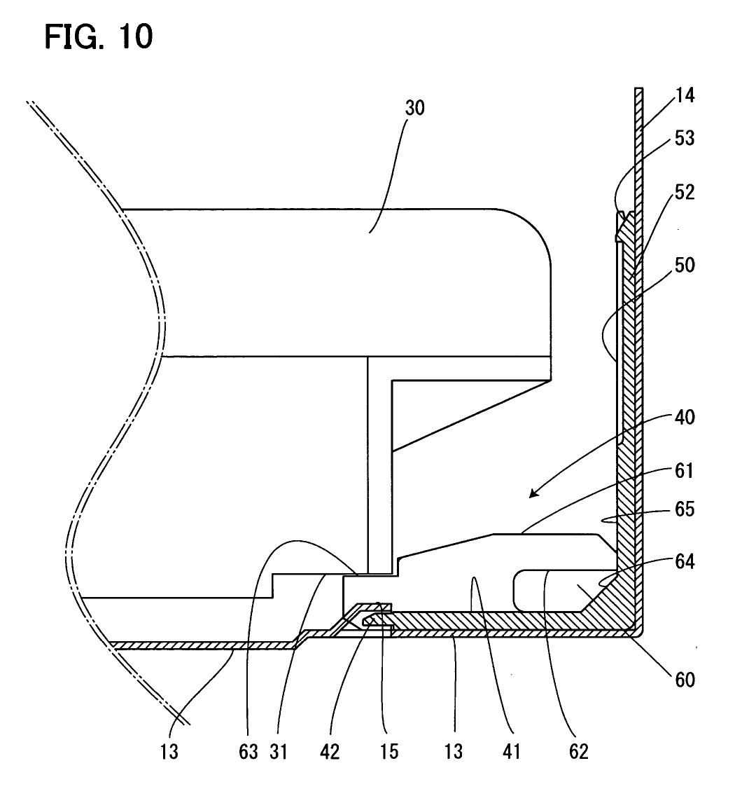

FIG. 1 is a perspective view showing a state in which a flat cable and loose wires are held by a cable holder which shows the embodiment 1 in the present invention, FIG. 2 is a plane view of the cable holder. FIG. 3 is a side view of the cable holder, and FIG. 4 is a front view of the cable holder. FIG. 5 is a plane view of a chassis of a DVD device, and FIG. 6 is an enlarged side sectional view of a projected part which is formed at the chassis. FIG. 7 is a plane view showing a state in which the cable holder is mounted to the chassis, and FIG. 8 is an enlarged plane view showing a state in which the cable holder is mounted to the chassis. FIG. 9 is a plane view showing a state in which a cable is laid by being held by the cable holder, and FIG. 10 is an enlarged side sectional view showing a state in which the cable holder is fixed by being pressed by a DVD unit.

With reference to FIGS. 1 to 4, the shape and the function of the cable holder will be described, but prior to this, an outline of a loose wires holding part, which is formed at a side wall vertically provided at a side end of a base portion of the cable holder, will be described with reference to FIGS. 2 and 3. A cable holder 40 shown in the plane view of FIG. 2 is formed of an ABS resin or the like of a synthetic resin material having elasticity, a locking piece 42 is formed to project to the front of a base part 41, and two side walls 61 are formed at both sides of the base part 41. At a rear side of the base part 41, a flat cable holding part 50 which is formed to be narrower than a space between the above described two side walls 61 and is a slit part which alternately sandwiches the flat cable 70 is vertically disposed by being extended from a loose wires stopper 64 formed by a raised wall 65 which is vertically provided at a rear end of the base part 41. Gaps between the two side walls 61 and the above described flat cable holding part 50 respectively secure gaps through which loose wires 80 shown in FIG. 1 can easily pass. According to the side view of FIG. 3, a notch 62 is laterally provided toward the front from a rear end of the above described side wall 61, and a loose wires holding part 60 that is a notch part which holds a plurality of loose wires 80 shown in FIG. 1 in a bound state is formed. The relationship between a space area (S) of the loose wire holding part 60 and a sectional area (s) in which a predetermined number of loose wires are bound according to FIG. 1 is (S)>(s). The raised wall 65 is vertically provided to be opposed to a notch 62 opening of the loose wires holding part 60, and the loose wires stopper 64 which prevents the loose wires 80 from removing from the loose wire holding part 60 is formed. Thereby, when the above described plurality of loose wires 80 are mounted, the plurality of loose wires 80 can be collectively housed and held as in FIG. 1 by a simple operation of binding the loose wires 80 and bending the loose wires 80, inserting the loose wires 80 through the loose wires holding part 60 formed by the above described notch 62 via the gaps between the above described two side walls 61 and the raised wall 65 which forms the loose wires stopper 64 while causing the loose wires 80 to bypass the above described raised wall 65, and straightening the bending of the loose wires 80 to be substantially linear. Meanwhile, when the loose lines 80 which are housed and held are to be removed from the cable holder 40, the loose wires 80 can be easily removed by bending the loose wires 80 and drawing them from the above described notch 62 by the operation in the reverse order from the operation at the time of housing. The cable holder 40 is a substantially L-shaped cable holder 40 in which the loose wires holding part 60 formed at both the side walls 61 of the base part 41 and the flat cable holding part 50 which is formed by extensively providing the raised wall 65 as the loose wires stopper 64 vertically provided at an opening side of the notch 62 which forms the loose wires holding part 60.

Next, the flat cable holding part 50 will be described with reference to FIG. 4. Three holding plates 52 are formed in the vertical direction by extending the above described raised wall 65. Of these three holding plates 52, the central holding plate 52 has a flat cable stopper 53, which is projected forward, formed at its tip end. Two slits 51 are notched and formed in respective spaces among the above described three holding plates 52. Here, relationship between the flat cable 70 shown in FIG. 1 and the flat cable holding part 50 shown in FIG. 4 is described. A thickness (w) of the flat cable 70 and a slit width (W) in the flat cable holding part 50 are in the relationship of (W)>(w), and the slit width (W) is set so as to make it possible to insert the flat cable 70 through the slit 51 easily. Relationship between a width (t) of the flat cable 70 and an effective length (T) in the holding plate 52 is (T)>(t), and the flat cable 70 can be easily inserted through the two slits 51. Thus, when the flat cable 70 is mounted to the flat cable holding part 50, the flat cable 70 is bent and inserted through the slit 51, and the flat cable 70 is restored from bending to be substantially flat. Alternatively, the flat cable 70 is inserted through the slits 51 by widening the gaps by pulling the two holding plates 52 at both sides. The flat cable 70 can be inserted through by alternately pressing the three holding plates 52 by being inserted through by pressing the central holding plate 52 and the like. By elasticity of the synthetic resin material such as ABS resin by which the three pressed holding plates 52 are biased to return to the flat position respectively, the three holding plates 52 can stably sandwich the flat cable 70 by alternately sandwiching the flat cable 70. Further, the sandwiched flat cable 70 can be prevented from removing by a flat cable stopper 53, and therefore, the flat cable 70 laid in the DVD device 10 can be stably held for a long period of time. Thereby, as shown in FIG. 1, the flat cable 70 and the plurality of loose wires 80 can be both held separately in one cable holder 40. When the flat cable 70 is to be removed from the cable holder 40, the flat cable 70 can be easily removed by only pressing the central holding plate 52 at which the flat cable stopper 53 is formed.

With reference to FIGS. 5 to 10, a mounting structure of the cable holder 40 to a chassis bottom plate 13 of the DVD device 10 will be described. FIG. 5 shows the chassis bottom plate 13 with the right side surface of the DVD device 10 as the front side. The chassis 12 is made of a metal having electric conductivity, a DVD unit not shown is disposed in a substantially center and printed boards not shown are disposed at the left and the right of the DVD unit inside the DVD device 10. Since the loose wires and the flat cable for electrically connecting the above described printed boards disposed at the left and the right are laid behind the DVD unit, in order to mount the cable holder 40 which holds them, projected portions 15 are formed at two spots by cutting and raising the chassis bottom plate 13.

Next, with reference to FIG. 6, the above described projected portions 15 formed at the chassis bottom plate 13 will be described. The projected portions 15 are formed at the two spots by cutting and raising the chassis bottom plate 13, and the cut and raised portions are opened toward the rear of the chassis 12 shown in FIG. 5. The locking piece 42 of the cable holder 40 is fitted into the opening of the cut and raised portion to be able to be positioned.

With reference to FIGS. 7 and 8, the state in which the above described cable holders 40 are mounted to the chassis 12 of the DVD device 10 will be described. The locking pieces 42 of the above described cable holder 40 are fitted into the above described projected portions 15 provided at the two spots of the above described chassis bottom plate 13 shown in FIG. 7, and the above described substantially L-shaped cable holders 40 mounted here are disposed with the base parts 41 in contact with the chassis bottom plate 13, and the flat cable holding parts 50 in contact with a chassis side plate 14 at the rear of the chassis 12. When the cable holder 40 is fitted and mounted, the locking piece 42 shown in FIG. 8 is initially fitted into the projected portion 15, and then the cable holder 40 is pushed in along the chassis side plate 14 to cause the bottom surface of the base part 41 to be in close contact with the chassis bottom plate 13. At this time, a rib 42a which supports the locking piece 42 is elastically deformed to cause the cable holder 40 to be pushed in, and after the it is pushed in, the rib 42a is biased by the restoring force to return to the original shape and pressed against an end surface of the projected portion 15 which is formed by being cut and raised, so that positioning and temporarily fixing of the cable holder 40 are achieved.

Next, with reference to FIG. 9, the wiring state of the cables 70 and 80 inside the DVD device 10 will be described. Reference numeral 11 shown in FIG. 9 denotes a front cabinet of the DVD device 10, operation buttons, display tubes, a shutter for inserting and ejecting a DVD disk, and the like are disposed at a front surface of the DVD device 10. A space in which the DVD unit not shown is disposed is secured in a substantially center of the chassis 12, and a first board 20 anda second board 21 which are main circuit boards of the DVD device 10 are disposed at both sides of the DVD unit. The first board 20 is an analogue circuit board which mainly controls an electric power supply circuit of the DVD device 10 and the entire device and processes analogue audio/video signals, from the rear side of which the flat cable 70 and the loose wires 80 are drawn out and connected to the second board 21. The second board 21 is a board on which a circuit that processes digital signals for mainly performing recording and playback of a DVD disk (not shown ) . The flat cable 70 and a plurality of loose wires 80 which connect them are laid by being held in the two cable holders 40 at the two spots at the rear side of the place where the above described DVD unit is disposed. The flat cable 70 laid in the DVD device 10 is a cable which transmits the above described digital signals, and a plurality of loose wires 80 are cables and the like which supply electric power to drive a mechanism part of the DVD unit 30 shown in FIG. 10 and supply electric power to the circuits, or transmit control signals by a CPU (Central Processing Unit) packaged on the first board 20.

Subsequently, with reference to FIG. 10, a method for fixing the cable holders 40 which are positioned and temporarily fixed in FIG. 8 by pressing them with the DVD unit 30 will be described. The cable holder 40 shown in FIG. 10 has a stepped recessed part 63 formed on the side wall 61 pressed in contact with a bottom part 31 of the DVD unit 30 with the bottom part 31 abutting on the stepped recessed part 63. The DVD unit 30 is fixed to the chassis 12 with screws at a plurality of spots not shown, and therefore, the DVD unit 30 can be firmly fixed.

As described above, according to the embodiment 1, in the cable holder 40, the flat cable holding part 50 constituted of the three holding plates 52 at the tip end, which sandwich the above described flat cable 70 by alternately disposing the flat cable 70, and the slit part formed by the slits 51 at the two spots are formed, and therefore, the flat cable 70 is inserted by alternately pressing the holding plates 52 at the tip end of the cable holder 40. Alternatively, the flat cable 70 is bent and alternately inserted through the above described holding plates 52 and the slits 51, and thereby, the flat cable 70 can be easily and stably sandwiched. The plurality of loose wires 80 can be collectively held easily in the bound state by the loose wires holding part 60 constituted of the notched parts formed in the two side walls 61 formed at the rear end side of the cable holder 40. Thereby, both the flat cable 70 and the plurality of loose wires 80 can be separately held in the one cable holder 40 with the flat cable 70 held at the tip end and a plurality of loose wires 80 at the rear end side, and since two kinds of cables with different kinds ofsignals suchas the flat cable 70 which transmits digital signals and the loose wires 80 which transmit analogue signals can be held separately, mutual interference by noises and unwanted radiations which are likely to occur between the cables with different signals can be prevented. The raised wall 65 as the stopper 64 for preventing removing is vertically provided at the end side of the opening of the notch 62, and when the above described plurality of loose wires 80 are inserted through the notch 62, the loose wires 80 can be collectively housed and held by a simple operation of binding and bending the loose wires 80, causing the loose wires 80 to bypass the above described raised wall 65, inserting them through the above described notch 62, and straightening the bending of the loose wires 80 to be substantially linear.

Further, in the above described cable holder 40, the flat cable holding part 50 constituted of the holding plates 52 for holding the flat cable 70 and the slit part by the slits 51, and the loose wires holding part 60 formed by the notched part for holding the loose wires 80 in the bound state are formed in the L shape, and therefore, the cable holder 40 can be disposed in the narrow space inside the electronic apparatuses such as the DVD device 10 to be able and hold the flat cable 70 and a plurality of loose wires 80. The cable holder 40 is disposed with the above described flat cable holder 50 vertical so that the cable holder 40 is in contact with the chassis side plate 14 of the electronic apparatuses such as the DVD device 10, and thereby, the unwanted radiation by the digital signals transmitted by the flat cable 70 can be reduced by the chassis side plate 14. On the other hand, the flat cable holding part 50 is disposed to be in contact with the chassis bottom plate 13 of the electronic apparatus such as the DVD device10, and thereby, the unwanted radiation by the digital signals transmitted by the flat cable 70 can be similarly reduced by the chassis bottom plate 13.

Since the flat cable stopper 53 which is the locking stopper for preventing the flat cable 70 from removing is formed at the tip end of the holding plate 52 of the above described cable holder 40, the flat cable 70 which is laid in the electronic apparatus such as the DVD device 10 is sandwiched by the flat cable holding part 50, and is inhibited from removing by the flat cable stopper 53, whereby the flat cable 70 can be stably held.

The cable holder 40 can be positioned by fitting the locking piece 42 formed at the base part 41 in the projected portion 15 cut and raised from the chassis bottom plate 13 of the DVD device 10, and can be fixed by pressing the bottom part 31 of the DVD unit 30 disposed in the DVD device 10 against the cable holder 40, and therefore, the cable holder can be easily and firmly mounted without needing to prepare a separate mounting member.

The cable holder 40 can be positioned by fitting the locking piece 42 formed at the base part 41 in the projected portion 15 cut and raised from the chassis bottom plate 13 of the DVD device 10, and can be fixed by pressing the bottom part 31 of the DVD unit 30 disposed in the DVD device 10 against the cable holder 40, and therefore, the cable holder can be easily and firmly mounted without needing to prepare a separate mounting member.

### Embodiment 2

Next, embodiment 2 in the present invention will be described. A cable holder in which a flat cable holding part is formed into a planar shape by extending a plane of a base part will be explained according to the embodiment 2.

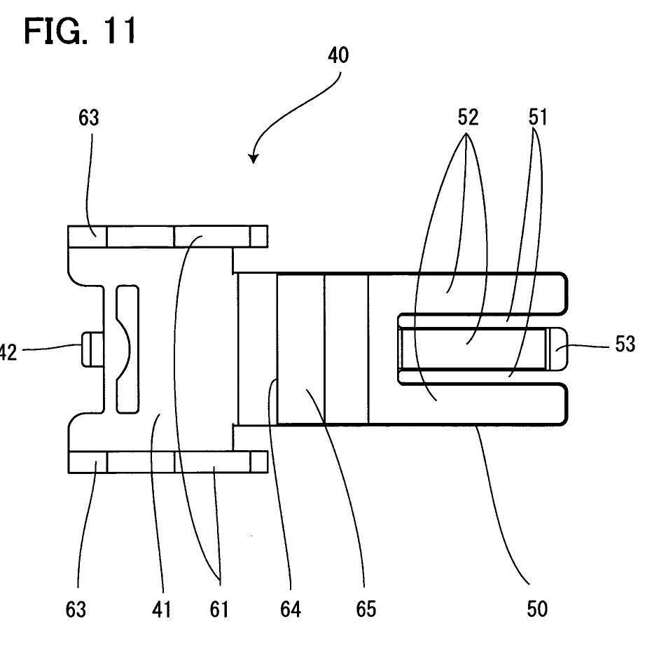

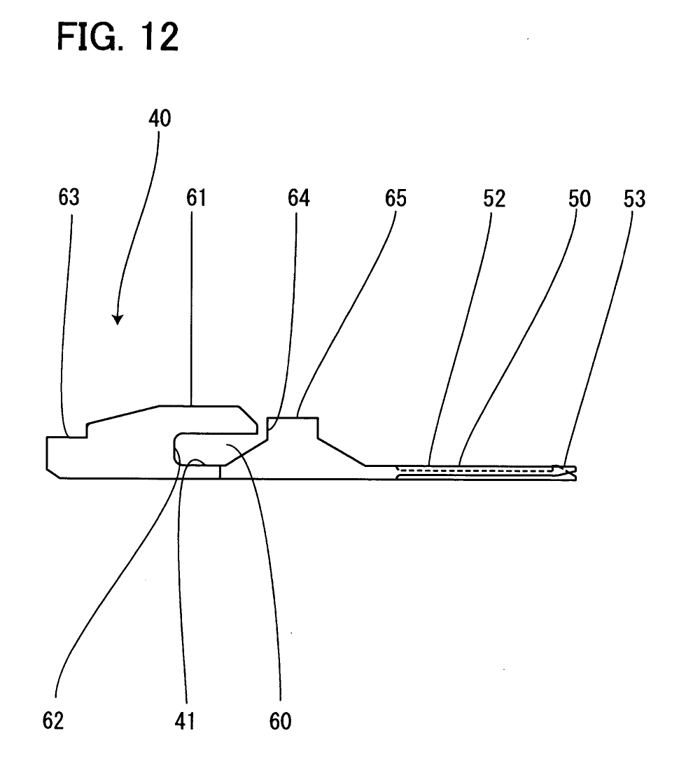

FIG. 11 is a plane view of the cable holder in which a flat cable holding part is formed into a planar shape. FIG. 12 is a side view of the cable holder. The cable holder 40 shown in FIG. 11 differs from that of the embodiment 1, and the flat cable holding part 50 is formed in the planar direction at a tip of the raised wall 65 of the loose wires stopper 64 formed at the open side of the notch 62 of the loose wires holding part 60. In its side surface, the plane of the base part 41 is extended in the planar shape to form the bottom surface of the above described raised wall 65 and the flat cable holding part 50 as shown in FIG. 12.

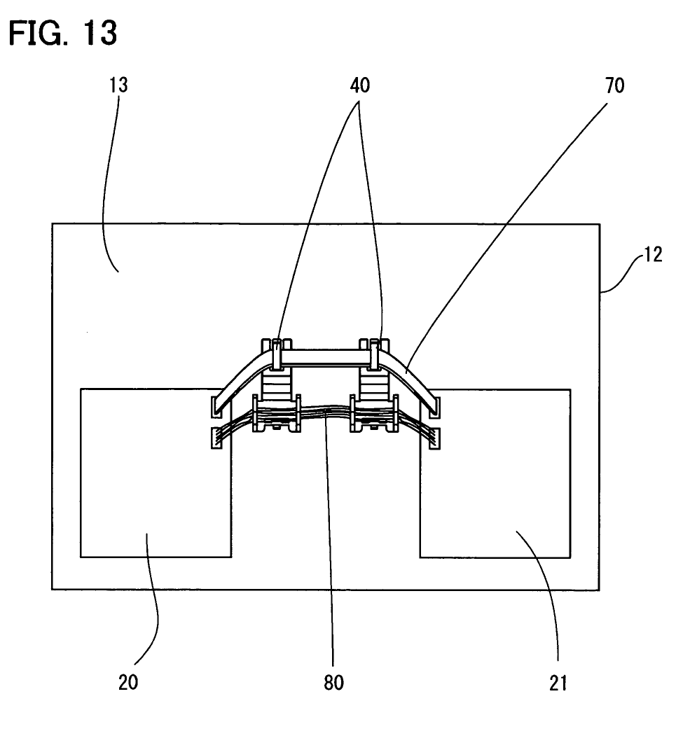

FIG. 13 shows the state in which the flat cable 70 and a plurality of loose wires 80 are laid inside the DVD device 10 and are held by the two cable holders 40. The basic arrangement inside the DVD device 10 of FIG. 13 is similar to that of FIG. 9 in the embodiment 1, but there is a margin in depth of the chassis 12 and the flat cable holding part 50 is disposed to be in contact with a plane of the chassis bottom plate 13. Explaining the outline of the respective arrangements inside the DVD device 10, a space where the DVD unit not shown is disposed is secured in a substantially center of the chassis 12, and the first board 20 and the second board 21 which are the main circuit boards of the DVD device 10 are disposed at both sides of the space for the DVD unit. The first board 20 is a circuit board which mainly controls an electric power supply circuit of the DVD device 10 and the entire device and processes analogue audio/video signals, from the back side of which the flat cable 70 and the loose wires 80 are drawn out and connected to the second board 21. The second board 21 is a board on which a circuit that processes digital signals for mainly performing recording and playback of a DVD disk (not shown) is constructed. The flat cable 70 and a plurality of loose wires 80 which connect them are laid by being held in the two cable holders 40 at the two spots at the rear side of the place where the above described DVD unit is disposed. The flat cable 70 laid in the DVD device 10 is a cable which transmits the above described digital signals, and the plurality of loose wires 80 are cables which supply electric power to drive a mechanism part of the DVD unit 30 shown in FIG. 10 and supply electric power to the circuits, or transmit analogue signals such as control signals by a CPU packaged on the first board 20.

As described above, according to the embodiment 2, in the cable holder 40, the flat cable holding part 50 which is the slit part that holds the flat cable 70 and the loose wires holding part 60 that is the notched part which holds the loose wires in the bound state are formed in the planar shape, and therefore, the cable holder 40 can be easily disposed even inside the electronic apparatus such as the DVD device 10 in which the disposition in the height direction is difficult. The flat cable 70 can be disposed so as to be in contact with the chassis bottom plate 13 of the electronic apparatus such as the above described DVD device 10, and therefore, an unwanted radiation by the digital signals transmitted by the flat cable 70 can be reduced by the chassis bottom plate 13.

### Embodiment 3

Next, embodiment 3 in the present invention will be described. A different mounting structure of the cable holder 40 will be described according to the embodiment 3.

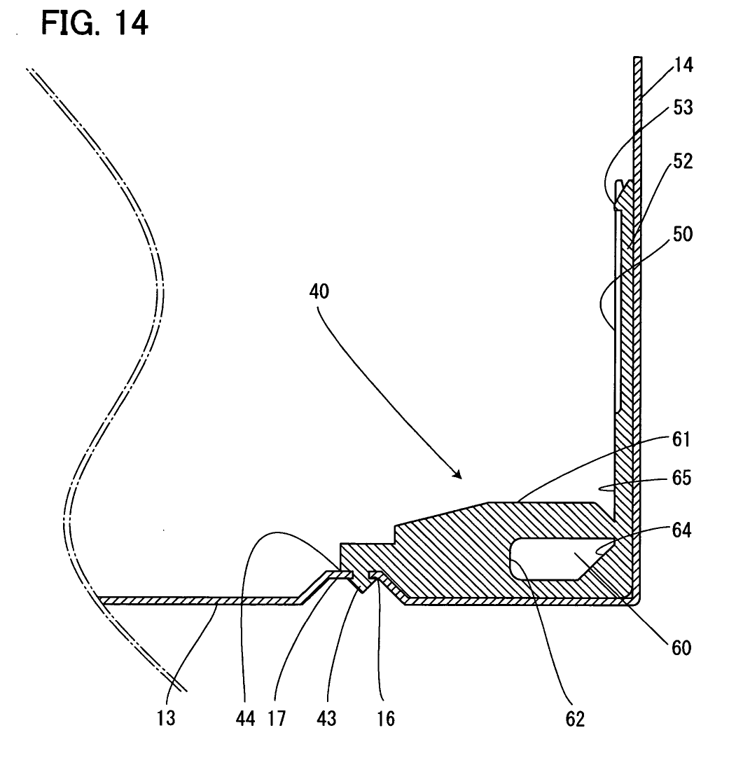

FIG. 14 is a side sectional view showing a state in which the cable holder is mounted to the chassis. A basic shape of the cable holder 40 is the same as that of the cable holder 40 according to the embodiment 1, and only the mounting structure to the chassis 12 differs. On the bottom surface of the base part 41 of the cable holder 40, a hook 43 which is a locking claw is formed at a positioning recessed portion 44, a positioning stepped projected portion 17 is formed at the chassis bottom plate 13 opposed to the recessed portion 44, and the cable holder 40 is positioned by the above described recessed portion 44 and the stepped projected portion 17, and is fixed by inserting the above described hook 43 through an opening of the locking hole 16 formed in the stepped projected portion 17 of the chassis bottom plate 13.

As described above, according to the embodiment 3, the cable holder 40 is positioned by the recessed portion 44 and the stepped projected portion 17 by only fitting the hook 43 formed at the recessed portion 44 at the bottom surface of the base part 41 into the locking hole 16 which is formed in the stepped projected portion 17 of the chassis bottom plate 13 of the DVD device 10, and by engaging the hook 43 with the locking hole 16, positioning and fixing can be performed at the same time, and therefore, the cable holder can be easily and firmly mounted without needing to prepare a separate mounting member. In this embodiment, the positioning means of the cable holder 40 is fitting of the recessed portion 44 and the stepped projected portion 17, but other than this, the cable holder 40 is positioned by providing a positioning through-hole or the recessed portion at the chassis bottom plate 13, providing a positioning projection at the base part 41, and fitting them. Alternatively, it is possible to change a positioning method to a method for forming a cut and raised rib at the chassis bottom plate 13, providing a recessed portion at the base part 41 bottom surface at the opposed position to the rib and fitting them, and the like.

The embodiments are described in detail above, but various modifications can be carried out within a range of the gist of the present invention. For example, the electronic apparatus including the cable holder 40 which holds the flat cable 70 and the loose wires 80 is not limited to the DVD device 10, but any electronic apparatuses in which two kinds of cables 70 and 80 in which different signals are transmitted are laid may be adopted, such as an HDD device, or a complex machine of a DVD and an HDD, a device made by combining these device and machine and a display monitor, and any electronic apparatus in which two kinds of cables 70 and 80 by which different signals are transmitted are laid, such as a digital television and a personal computer may be adopted. Change or the like of the mounting direction of the cable holder 40 may be properly selected if only the cable holder 40 is disposed in the laid position of the cables 70 and 80 in the electronic apparatus and the cable holder 40 is capable of being disposed so that the chassis bottom plate 13 or the chassis side plate 14 is in contact with the flat cable 70.

The effects of the present invention are as follows.

According to the invention of the first aspect, in the cable holder, the slit part which sandwiches the flat cable by alternately disposing the flat cable is formed at its tip end, and therefore, the flat cable is inserted through the slit part by alternately pressing the tip end of the cable holder. Alternatively, the flat cable is bent and alternately inserted through the slit part, and thereby, the flat cable is easily and stably sandwiched. By the notched part formed at the rear end side of the cable holder, the plurality of loose wires can be easily and collectively held in the bound state. Thereby, both the flat cable and the plurality of loose wires can be held in one cable holder by separating them so that the flat cable is held at the tip end and the plurality of loose wires at the rear end side, and two kinds of cables with different kinds of signals such as the flat cable which transmits digital signals and the loose wires which transmit analogue signals can be separately held. Therefore,mutual interferences by noises and unwanted radiations which are likely to occur between the cables with different signals can be prevented.

According to the invention of the second aspect, in the cable holder, the slit part which holds the flat cable and the notched part which holds the loose wires in the bound state are formed in the L-shape, and therefore, the cable holder can be disposed in a small space inside the electronic apparatus and hold the flat cable and the plurality of loose wires. If the flat cable holding part is vertically disposed so that the cable holder is in contact with the side plate of the chassis of the electronic apparatus, unwanted radiations by the digital signals transmitted by the flat cable can be reduced by the side plate of the chassis. On the other hand, if the flat cable holding part is disposed to be in contact with the chassis bottom plate of the electronic apparatus, unwanted radiations by the digital signals transmitted by the flat cable can be similarly reduced by the bottom plate of the chassis.

According to the invention of the third aspect, the slit part which holds the flat cable and the notched part which holds the loose wires in the bound state are formed in the planar shape, and therefore, the cable holder can be easily disposed inside the electronic apparatus in which disposition in the height direction is difficult. The flat cable can be disposed to be in contact with the chassis bottom plate of the electronic apparatus, and therefore, unwanted radiations by the digital signal transmitted by the flat cable can be reduced by the bottom plate of the chassis.

According to the invention of the fourth aspect, the locking stopper which prevents the flat cable from removing is formed at the tip end of the cable holder, and therefore, the flat cable laid inside the electronic apparatus can be stably held by being sandwiched by the slit part and inhibited from removing by the locking stopper.

What is claimed is:

1. An electronic apparatus including a cable holder which holds a flat cable constructed by a plurality of cores and a plurality of loose wires, which are laid,
wherein a slit part which sandwiches the flat cable by alternately disposing the flat cable is formed at a tip end of the cable holder, and a notch part which holds the plurality of loose wires in a bound state is formed at a rear end side that is located at an opposite side from the tip end.

2. The electronic apparatus including the cable holder according to claim 1, wherein the cable holder is formed in an L-shape.

3. The electronic apparatus including the cable holder according to claim 1, wherein the cable holder is formed in a planar shape.

4. The electronic apparatus including the cable holder according to claim 1, wherein a locking stopper is formed at a tip end of the cable holder.

5. The electronic apparatus including the cable holder according to claim 2, wherein the locking stopper is formed at the tip end of the cable holder.

6. The electronic apparatus including the cable holder according to claim 3, wherein the locking stopper is formed at the tip end of the cable holder.
